(19) United States
(12) Patent Application Publication
(10) Pub. No.: US 2014/0060097 A1
(43) Pub. Date: Mar. 6, 2014

(54) REFRIGERATED TRUCK BATTERY BACK-UP SYSTEM AND RELATED METHODS

(71) Applicant: Philip PERREAULT, Sanford, FL (US)

(72) Inventor: Philip PERREAULT, Sanford, FL (US)

(21) Appl. No.: 14/016,400

(22) Filed: Sep. 3, 2013

Related U.S. Application Data
(60) Provisional application No. 61/695,847, filed on Aug. 31, 2012.

(51) Int. Cl. B60H 1/00

(52) U.S. Cl. CPC B60H 1/00378
USPC 62/133

(57) ABSTRACT

A refrigerated truck may include a refrigerated compartment, and an active refrigeration device for cooling the compartment. The refrigerated truck may include a power module for powering the active refrigeration device, and selectively coupling the battery to a grid power connection.

### RELATED APPLICATIONS

This application is based upon prior filed copending application Ser. No. 61/695,847 filed Aug. 31, 2012, the entire subject matter of which is incorporated herein by reference in its entirety.

### FIELD OF THE INVENTION

The present invention relates to the field of refrigeration trucks, and, more particularly, to refrigeration truck power systems and related methods.

### BACKGROUND OF THE INVENTION

In a vibrant economy, it is necessary to move goods and products throughput the country. This transportation must be economically efficient or the final price of the goods will be problematic. In the United States, the most common modes of transportation for goods and products are truck, train, and plane. Transportation by plane is a relatively fast form of transportation, but is also the most costly. The train offers large capacity and reduced cost, but it is limited by the railroad infrastructure penetration. Indeed, the most common and versatile form of transportation for goods and products is the truck, such as a semi-trailer truck.

Depending on the good or product, it may be necessary to refrigerate the storage compartment of the semi-trailer truck, i.e. a refrigerated truck. For example, perishable food products must be refrigerated during transport. Some semi-trailer trucks may have a passive cooling system, such as dry ice or liquid carbon dioxide. Other trucks may have an active refrigerating system, for example, a compressor utilizing a liquid coolant. Trucks with active refrigerating systems require a power source of some form to drive the refrigerating system. One approach may comprise coupling the refrigerating system to the drive system of the semi-trailer truck. Another approach may comprise providing a separate dedicated engine (e.g. diesel engine) to drive the compressor of the refrigeration system.

A potential drawback to these approaches is that they both consume fuels of some form. Indeed, in city environments where the truck may idle for long periods of time due to traffic, the fuel efficiency of such approaches may be poor. In an effort to reduce fuel consumption and vehicle emissions, many municipalities have passed truck idling regulations, which prohibit trucks from idling either their main drive engines or dedicated refrigeration engines for extended periods of time.

### SUMMARY OF THE INVENTION

In view of the foregoing background, it is therefore an object of the present invention to provide a refrigerated truck that is efficient and robust.

This and other objects, features, and advantages in accordance with the present invention are provided by an electrical mobile power system that may comprise a programmable energy conversion module that is capable of accepting alternating current (AC) or direct current (DC) voltage inputs and providing a 3Ø, 208V AC output configured to power a truck refrigeration system. The system may be coupled with a battery bank that provides the DC voltage input to the unit while mobile and when connected to AC voltage shore power, the system will continue to power the refrigeration system and recharge the battery bank simultaneously. The system was designed and intended as a cleaner alternative power system for mobile refrigeration systems that cannot be powered from a diesel engine due to regulations.

### BRIEF DESCRIPTION OF THE DRAWINGS

FIG. 1 is a schematic diagram of a refrigerated truck, according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

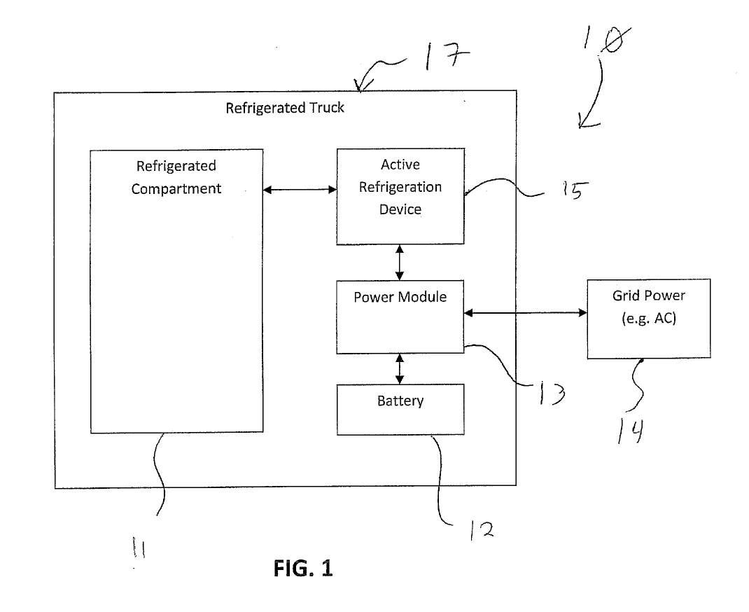

Referring now to FIG. 1, a refrigerated truck system 10 according to the present invention is now described. The refrigerated truck system 10 illustratively includes a refrigerated truck 17 comprising a refrigerated compartment 11, and an active refrigeration element 15 coupled thereto for cooling the compartment. The active refrigeration element 15 may comprise a typical coolant based system, i.e. comprising a compressor, a condenser, and an evaporator, each moving coolant in the system. The refrigerated truck 17 illustratively includes a power module 13, and a battery 12 coupled thereto.

The battery 12 may comprise a plurality of batteries coupled in series, such as lead acid car batteries. In some embodiments, the battery 12 may comprise a customized lithium ion battery. As for the location of the battery 12, the battery may be located on the exterior of the refrigerated compartment 11, or may be located within the refrigerated compartment. The battery 12 may also be located in a passenger compartment of the refrigerated truck 17.

The refrigerated truck system 10 illustratively includes grid power 14 (e.g. power receptacle). When the refrigerated truck 17 is being loaded and unloaded adjacent a structure (e.g. loading dock), the power module 13 may be coupled to the grid power 14. For example, the grid power 14 may provide 120V (3 phase) or 208V AC (3 phase). The power module 13 may provide three phase (3Ø), 208V AC for powering the active refrigeration device 15.

The refrigerated truck 17 may comprise a retractable cable for coupling the power module 13 to the grid power 14. While coupled to the grid power 14, the power module 13 detects the coupling to the grid power, and powers the active refrigeration device 15 and charges the battery 12 using the grid power. Once disconnected, the power module 13 switches to the battery 12 as the power source for the active refrigeration device 15. Accordingly, as the refrigerated truck 17 is operated and mobile, the refrigerated temperature of the refrigerated compartment 11 is maintained.

In some embodiments, the refrigeration system of the refrigerated truck 17 may be isolated from the typical electrical systems (main drive train, alternator, and battery) of the refrigerated truck. In other embodiments, the power module 13 may selectively charge the battery 12 using the alternator. In other embodiments, the refrigerated truck 17 may comprise a supplemental electrical generator (e.g. fuel based generator) to selectively charge the battery 12. The passenger compartment of the refrigerated truck 17 may include a toggle switch to selectively enable this supplemental charging feature. In other words, the user of the refrigerated truck 17 may enable supplemental charging of the battery 12 only when necessary, or when operating the truck outside the jurisdiction of typical municipal idling regulations.

In yet other embodiments, the refrigerated truck 17 may use regenerative braking in conjunction with an electrical generator to charge the battery 12 during typical operation. In some embodiments, the above described refrigeration system may serve as a supplement to typical refrigeration power systems, such as a small gasoline power generator. In these embodiments, the passenger compartment of refrigerated truck 17 may include a toggle switch for powering the active refrigeration device 15 using the battery 12 or the typical power element.

Advantageously, the refrigerated truck 17 may cool the refrigerated compartment 11 using only the battery 12, which is charged from the grid power 14. The refrigerated truck 17 may then satisfy municipal idling regulations.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A refrigerated truck comprising:
a truck frame;
a motor carried by said truck frame;
a refrigerated compartment carried by said truck frame; and
an active refrigeration device carried by truck frame and for cooling said refrigerated compartment;
a battery carried by said truck frame;
a power module carried by truck frame and for
during normal operation, selectively powering said active refrigeration device with at least one of said battery and said motor,
during an idling operation, disabling said motor and powering said active refrigeration device with said battery, and
when a grid power connection is available, selectively charging said battery with the grid power and powering said active refrigeration deice with grid power.

2. The refrigerated truck of claim 1 further comprising an alternator coupled to said motor and for charging said battery during the normal operation.

3. The refrigerated truck of claim 1 further comprising a generator for selectively charging said battery during the normal operation.

4. The refrigerated truck of claim 1 further comprising a retractable cable for coupling said power module to the grid power connection.

5. The refrigerated truck of claim 1 wherein said power module powers said active refrigeration device only with said battery.

6. The refrigerated truck of claim 1 wherein said power module, when the idling operation exceeds a threshold time value, disables said motor and powers said active refrigeration device with said battery.

7. The refrigerated truck of claim 1 wherein said battery comprises a plurality thereof.
